(19) United States
(12) Patent Application Publication
(10) Pub. No.: US 2005/0243170 A1
(43) Pub. Date: Nov. 3, 2005

(54) Speed dome

(76) Inventor: Pao Chin Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/823,754

(22) Filed: Apr. 14, 2004

(51) Int. Cl. H04N 7/18

(52) U.S. Cl. 348/143

(57) ABSTRACT

A speed dome has a monitor module used to shoot nearby scenes, position-controlling devices used to control horizontal and vertical angles, and bracing plates used to brace the monitor module. The bracing plates have a circuit used to drive the monitor module and the position-controlling devices. The circuit serves to communicate with an external peripheral (a remote controller or computer), transmit image signals and electric power, and so on. Hence, the bracing plates are circuit printed boards (PCBs) and constitute the main body of the speed dome. In this way, the weight of the speed dome can be reduced and the size of the driving motors can also be small. Further, the speed for developing new products can be quickened, the cost for developing the products can be reduced, and the time for testing the products or entering the market can be shortened.

### FIELD OF THE INVENTION

The present invention is directed to a speed dome, and more particularly, to a speed dome that employs a main body made of printed circuit boards (PCBs) to brace a monitor module and position controllers thereof.

### BACKGROUND OF THE INVENTION

At present, there exist various modern modes of transportation, such as trains, airplanes, rapid transit systems, buses and so forth. With these modes of transportation, places such as train stations, bus stations, airports, rapid transit stations and so forth often have an “eye”, called a monitor, disposed in a corner thereof.

The monitor may not only be disposed in the places mentioned above but also in various meeting places. The monitor is located in these places for security or monitoring.

Reference is made to FIG. 1, which is a schematic diagram of a conventional monitor. The monitor primarily includes a complicated metal main body 9, multiple printed circuit boards (PCBs) 2, 3, 4, 5, 6, a camera 1, multiple rotators 7, 8 and two motors. One of the motors is used to control the horizontal direction and the other is used to control the vertical direction.

The complicated metal main body 9 of the monitor is used to brace the whole monitor. The PCBs 2-6 are used to transmit signals to the motors for controlling the movement of the monitor. The motors perform rotation or moving functions, e.g. horizontal or vertical movement, via the rotating units 7, 8. Further, the PCBs 2-6 are also used to transmit signals to the camera 1 to make it shoot nearby scenes.

However, the conventional monitor mentioned above still has drawbacks. Since its control circuits and molds are costly, the price of the conventional monitor is very high. Further, since the conventional monitor is heavy, the horsepower of the monitors should be large for rotating the main body. Hence, it will waste the energy and increase the circuit complexity.

Accordingly, as discussed above, the prior art still has some drawbacks that could be improved. The present invention aims to resolve the drawbacks in the prior art.

### SUMMARY OF THE INVENTION

An objective of the present invention is to provide a speed dome, including elements as follows. A monitor module is used to shoot scenes nearby. A plurality of position-controlling devices is used to control a horizontal angle and a vertical angle of the monitor module. A plurality of bracing plates is used to brace the monitor module and driving device. The bracing plates have a circuit disposed thereon, and the circuit is used to drive the monitor module and the position-controlling devices. Further, the circuits can also serve to communicate with external peripherals (such as a remote controller or computer), transmit image signals and electric power, and so on. Hence, the bracing plates are circuit printed boards (PCBs) and constitute the main body of the speed dome.

The present invention employs PCBs having circuits disposed thereon to constitute a main body of a speed dome. In this way, the weight of the speed dome can be reduced and the size of the driving motors can also be small. Further, the speed for developing new products can be quickened, the cost for developing the products can be reduced, and the time for testing the products or entering the market can be shortened.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a conventional monitor;

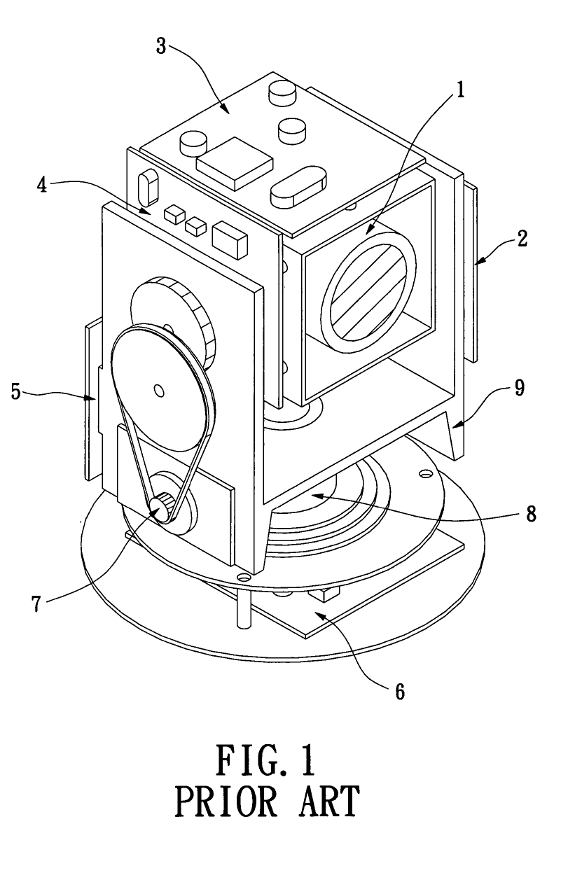

FIG. 2 is a schematic diagram of a speed dome in accordance with the present invention; and

FIG. 3 is a schematic diagram of a preferred speed dome in accordance with the present invention.

### DETAILED DESCRIPTION

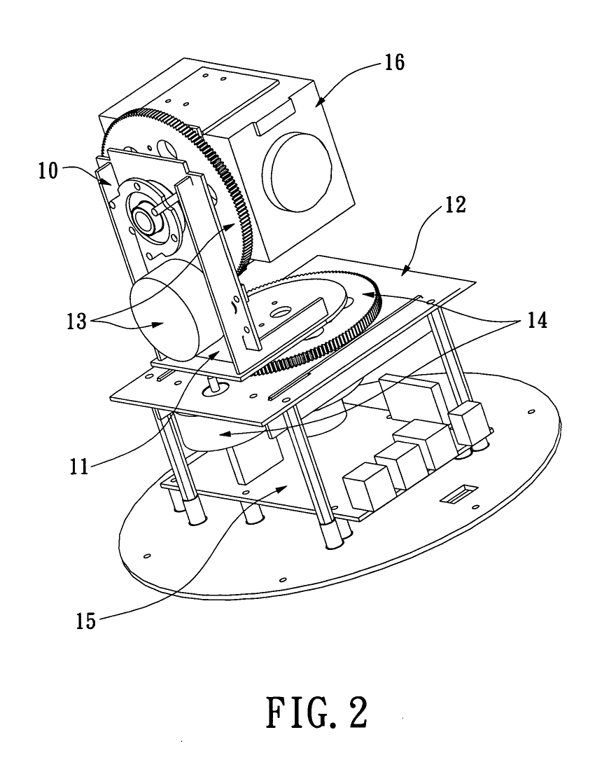

Reference is made to FIG. 2, which is a schematic diagram of a speed dome in accordance with the present invention. It includes a monitor module 16 used to shoot nearby scenes. The monitor module 16 is a charge coupled device (CCD). Multiple position-controlling devices 13, 14 are used to control the horizontal or vertical angle of the monitor module 16, and the position-controlling devices 13, 14 further include two motors respectively used to control the horizontal and vertical angles. Multiple bracing plates 10, 11, 12 are used to brace the monitor module 16, driving device and so on, and the bracing plates 10-12 have control circuits directly disposed thereon.

The control circuits are used to drive the monitor module 16 and the position-controlling device 13, 14. Further, the circuits can also serve to communicate with external peripherals (such as a remote controller or computer), transmit image signals and electric power, and so on.

Consequently, the bracing plates 10-12 not only serve as PCBs but also constitute a main body of the speed dome. The bracing plates 10-12 are made of fiberglass and the circuits include a monitor control unit and a position control unit.

Furthermore, during operation, the monitor module 16 will send image signals to the communication module 15 for compression. After compression, the image signals will be sent to a network by the communication module 15 through a RJ45 connector. Additionally, control signals may be sent by a user to make the monitor module 16 zoom in, zoom out or perform other functions built in the monitor module 16. At the same time, the user may also send a command to the horizontal or vertical control device for controlling the direction and monitoring.

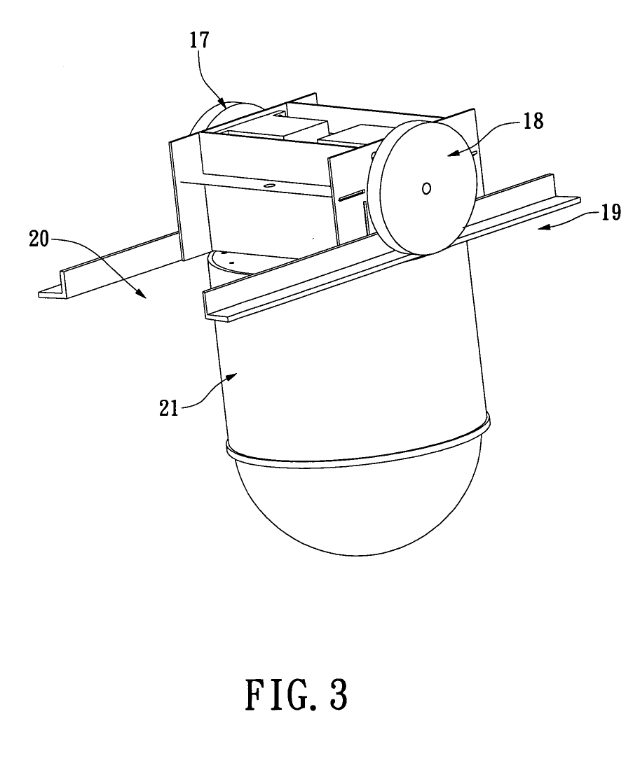

Reference is made to FIG. 3, which is a schematic diagram of a preferred speed dome in accordance with the present invention. It includes a monitor module 21, multiple wheels 17, 18 and multiple tracks 19, 20. In the embodiment, the present invention can move along the tracks 19, 20 via the wheels 17, 18. Hence, the present invention has no dead space.

The main objective of the present invention is to combine the PCB and main body of the conventional monitor, which are separated in the prior art, to lower the cost. Further, since the main body of the present invention can be made of fiberglass, bakelite, pottery, paper-based material, metal, polyester, polyimde or thermoplastic material, the main body of the present invention can be modified freely. For example, the main body can be minimized, magnified, shortened or widened. Besides, since the fiberglass is light, the present invention doesn't need motors with large horsepower. Hence, the size of the motors employed in the present invention can be small.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A speed dome, comprising:
a monitor module used to shoot nearby scenes;
a plurality of position-controlling devices used to control a horizontal angle and a vertical angle of the monitor module; and
a plurality of bracing plates used to brace the monitor module, the bracing plates having a circuit disposed thereon, wherein the circuit is used to drive the monitor module and the position-controlling devices, and the bracing plates are circuit printed boards (PCBs).

2. The speed dome as claimed in claim 1, wherein the monitor module is a charge coupled device (CCD)

3. The speed dome as claimed in claim 1, wherein the position-controlling devices further comprise two motors respectively used for controlling the horizontal angle and the vertical angle.

4. The speed dome as claimed in claim 1, wherein the bracing plates are made of fiberglass.

5. The speed dome as claimed in claim 1, wherein the bracing plates are made of bakelite, pottery, paper-based material, metal, polyester, polyimde or thermoplastic material.

6. The speed dome as claimed in claim 1, wherein the circuit comprises a camera control unit and a position control unit.
